(19) United States
(12) Patent Application Publication
(10) Pub. No.: US 2026/0086545 A1
(43) Pub. Date: Mar. 26, 2026

(54) ENHANCED POWER GRID SECONDARY ASSET MANAGEMENT

(71) Applicant: GE Infrastructure Technology LLC, Greenville, SC (US)

(72) Inventors: Balakrishna PAMULAPARTHY, Hyderabad (IN); Manoj KUMAR, Hyderabad (IN); Adriano Oliveira PIRES, Florianópolis (BR)

(73) Assignee: GE Infrastructure Technology LLC, Greenville, SC (US)

(21) Appl. No.: 18/894,267

(22) Filed: Sep. 24, 2024

(51) Int. Cl. G05B 23/02

(52) U.S. Cl. CPC G05B 23/0221; G05B 23/0281

(57) ABSTRACT

Devices, systems, and methods for managing intelligent electronic devices (IEDs) in a power system includes a method including sending, by IEDs in a power system, secondary asset management data of the IEDs to a device management system in communication with the IEDs; registering baseline device profiles for the IEDs based on the secondary asset management data; comparing additional secondary asset management data from the IEDs to the baseline device profiles; identifying deviations between the additional secondary asset management data and the baseline device profiles; determining, based on the deviations, a respective risk index for each of the IEDs; determining a respective risk influence factor for each of the IEDs; determining, based on the respective risk index and the respective risk influence factor for each of the IEDs, a final risk index for each of the IEDs; and ranking a fleet of the IEDs.

### TECHNICAL FIELD

This disclosure generally relates to power grid management, and more particularly to power grid secondary asset management.

### BACKGROUND

Intelligent electronic devices (IEDs) are computerized protection devices and controllers of power system equipment, particularly digital substations and grids. It is challenging to track IEDs for a fleet and to pinpoint an IED issue.

### SUMMARY

A method for managing intelligent electronic devices (IEDs) or secondary assets in a power grid or industrial system, which further protect, monitor, and manage primary assets comprising a transformer, a generator, and motor, and which control an associated breaker in case of faults or events, based on measured data sent from associated current and voltage transformers in the grid or industrial system, the method comprising: sending, by IEDs in a power system, secondary asset management data of the IEDs to at least device of a device management system or software in communication with the IEDs; receiving, by the at least one device, the secondary asset management data and additional secondary asset management data from the IEDs to map each secondary asset unique tag (IED) with a corresponding primary asset and an associated breaker, and current and voltage transformer unique tags in a database; during a baseline period, registering, by the at least one device, baseline device profiles for the IEDs using the retrieved secondary asset management data and the additional secondary asset management data; forming, by the at least one device, baseline IED clusters based on similar statistical data profiles of the IEDs and applications, ages, and manufacturer type of the IEDs; during a monitoring period, comparing, by the at least one device, latest retrieved secondary asset management data from the IEDs to the baseline device profile of a same IED and a corresponding IED cluster profile of the same IED; during the monitoring period, identifying, by the at least one device, based on the comparing, deviations between the latest secondary asset management data and at least one of the baseline device profile or the corresponding IED cluster profile; during the monitoring period, determining, by the at least one device, based on the deviations, a respective risk index for each of the IEDs; during the monitoring period, determining, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs; during the monitoring period, determining, by the at least one processor, based on the respective risk index and the respective risk influence factor for each of the IEDs, a final risk index for each of the IEDs; and ranking, by the at least one processor, a fleet of the IEDs based on the final risk index for each of the IEDs.

A non-transitory computer-readable medium comprising instructions that when executed by processing circuitry of a power system cause the processing circuitry to: send, by IEDs in a power system, secondary asset management data of the IEDs to at least device of a device management system or software in communication with the IEDs; receive, by the at least one device, the secondary asset management data and additional secondary asset management data from the IEDs to map each secondary asset unique tag (IED) with a corresponding primary asset and an associated breaker, and current and voltage transformer unique tags in a database; during a baseline period, register, by the at least one device, baseline device profiles for the IEDs using the retrieved secondary asset management data and the additional secondary asset management data; form, by the at least one device, baseline IED clusters based on similar statistical data profiles of the IEDs and applications, ages, and manufacturer type of the IEDs; during a monitoring period, compare, by the at least one device, latest retrieved secondary asset management data from the IEDs to the baseline device profile of a same IED and a corresponding IED cluster profile of the same IED; during the monitoring period, identify, by the at least one device, based on the comparing, deviations between the latest secondary asset management data and at least one of the baseline device profile or the corresponding IED cluster profile; during the monitoring period, determine, by the at least one device, based on the deviations, a respective risk index for each of the IEDs; during the monitoring period, determine, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs; during the monitoring period, determine, by the at least one processor, based on the respective risk index and the respective risk influence factor for each of the IEDs, a final risk index for each of the IEDs; and rank, by the at least one processor, a fleet of the IEDs based on the final risk index for each of the IED.

A system for managing intelligent electronic devices (IEDs) in a power system, the system comprising memory coupled to at least one processor, wherein the at least one processor is configured to: send, by IEDs in a power system, secondary asset management data of the IEDs to at least device of a device management system or software in communication with the IEDs; receive, by the at least one device, the secondary asset management data and additional secondary asset management data from the IEDs to map each secondary asset unique tag (IED) with a corresponding primary asset and an associated breaker, and current and voltage transformer unique tags in a database; during a baseline period, register, by the at least one device, baseline device profiles for the IEDs using the retrieved secondary asset management data and the additional secondary asset management data; form, by the at least one device, baseline IED clusters based on similar statistical data profiles of the IEDs and applications, ages, and manufacturer type of the IEDs; during a monitoring period, compare, by the at least one device, latest retrieved secondary asset management data from the IEDs to the baseline device profile of a same IED and a corresponding IED cluster profile of the same IED; during the monitoring period, identify, by the at least one device, based on the comparing, deviations between the latest secondary asset management data and at least one of the baseline device profile or the corresponding IED cluster profile; during the monitoring period, determine, by the at least one device, based on the deviations, a respective risk index for each of the IEDs; during the monitoring period, determine, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs; during the monitoring period, determine, by the at least one processor, based on the respective risk index and the respective risk influence factor for each of the IEDs, a final risk index for each of the IEDs; and rank, by the at least one processor, a fleet of the IEDs based on the final risk index for each of the IEDs.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for secondary asset management of intelligent electronic devices (IEDs) in a power system in accordance with one embodiment of the present disclosure.

FIG. 2 illustrates an example secondary asset management process in accordance with one embodiment of the present disclosure.

FIG. 3 is an example flow representing a process for secondary asset management of IEDs in a power system in accordance with one embodiment of the present disclosure.

FIG. 4 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Devices of power transformers, such as relays, switches, transformers, circuit breakers, and the like, may be processor-controlled as intelligent electronic devices (IEDs). IEDs form the brain behind operations of digital substations and grids. Without integration of device management framework, it is hard for a substation engineer to quickly pinpoint an issue with IEDs when an issue occurs. IEDs are secondary assets (e.g., in contrast with primary assets such as transformers, breakers, motors, generators, etc.) of power system equipment.

In one or more embodiments, device management software may track the status, performance, operations, patches, and/or vulnerabilities, and may assess risks for each IED of a fleet. A key differentiation and key use-cases of the secondary asset management system with respect to existing solutions include utilizing an IED's data effectively (e.g., both operational and non-operational data), deriving process/performance/health/CCS (Communications & Cyber Security) analytics from the IEDs data at substation level, extracting intelligence at fleet level combining each substation's IED data, providing actionable insights (e.g., a risk index/score) to operators for end-end management of all secondary assets (IEDs), and increasing overall grid reliability, security, and availability.

Digital twins refer to virtual representations (IEDs) of physical assets in a power system. As the number of IEDs introduced in the field increases, managing the devices and protecting their security is becoming more challenging. The enhanced techniques herein improve the accuracy of detection and allow for a more precise recognition of where an IED issue occurs.

In one or more embodiments, a device profile may be created using a variety of data types, such as operational data, non-operational data, communication data, cybersecurity performance, and the like. A baseline profile for a given device may indicate baseline performance of the different data types, and may be used to measure a device's (e.g., IED) performance over time. Each IED may establish a baseline profile, or a cluster of like IEDs may combine their data to establish a baseline profile for each IED in the cluster (e.g., a 1:1 baseline versus a 1:N baseline).

In one or more embodiments a device baseline profile may include primary asset health, breaker health, current transformer (CT)/potential transformer (PT) health, IED age/runtime, cybersecurity, real-time clock time accuracy, computer performance, communication latency (e.g., for any ports), breaker operation time (e.g., fault level versus operation time), and CT/PT accuracy. The baseline profile data may include historical data of the modes described above.

In one or more embodiments, the device management software may generate a monitoring profile for each IED. The monitoring profile may include a primary asset condition, a circuit breaker condition, a CT/PT condition, IED age versus warranty, cybersecurity adherence, real-time clock deviations, computer performance deviations, communication latency deviations/port, control operation time deviations, and CT/PT data errors. The monitoring software may compare the monitoring profile of a given IED to the baseline profile (e.g., of the IED and/or of the cluster that includes the IED) to detect a deviation indicative of an issue with the IED. Alternatively or in addition, the monitoring profile of an IED may be compared to the baseline profile of another IED (e.g., an IED in a same cluster). The comparisons may be short-term or long-term comparisons, meaning that the time windows during which the monitored data are compared to the baseline profiles may vary in length (e.g., not just a single data point at one time, but multiple data points over time compared to the baseline). The baseline comparison may vary based on the type of data being monitored. For example, a cluster baseline may be used for comparison in the monitoring mode for communication latency data, while the baseline for the individual IED may be used for comparison in the monitoring mode for computer loading data. A short-term monitoring mode period may be used for real-time clock accuracy data, whereas a longer-term monitoring mode period may be used for cybersecurity adherence. These are just examples that are not meant to be limiting.

In one or more embodiments, to form an IED cluster, groups of like IEDs (e.g., IEDs with shared or similar characteristics) may be clustered. For example, IEDs of a respective manufacturer or manufacturing year may form a cluster. IEDs with a similar age or runtime may form a cluster. IEDs with a same functionality may form a cluster. IEDs with a similar baseline profile may form a cluster. These are just some examples of how like IEDs may form clusters.

In one or more embodiments, the risk factor for an IED may be influenced based on IED risk influence factors such as the primary asset condition (e.g., condition of a primary asset such as a transformer, etc.), breaker condition, CT/PT condition, and/or IED environment (e.g., temperature and humidity of the environment of the IED). In this manner, the IED risk factor is determined, and then the IED risk influence factors may be used to adjust the IED risk factor. A reason for this is because the internal parameters used in the monitoring mode may not reflect auxiliary conditions or environment of an IED that are indicated by the IED risk influence factors. For example, if there is a problem indicated by the IED risk influence factors, then the IED risk determined based on the monitoring comparison to a baseline may be increased as a result. IEDs not influenced by the IED risk influence factors may be ranked on one table, and IEDs influenced by the IED risk influenced factors may be ranked in another table to signal which IEDs are influenced by external conditions and which are not.

In one or more embodiments, with regard to the measurement types (e.g., for the risk index and for the risk influence factors), communication latency may refer to statistics of a port, channel, and/or protocol communication throughput (e.g., delay and bandwidth). Computer (CPU) loading may refer to statistics of processors CPU load and memory consumption. Real-time clock accuracy may refer to statistics of IED real-time clock time accuracy in parts per second/parts per million. CT/PT data accuracy may refer to statistics of measurement errors (e.g., per the IEC 60044-1 standard). Cybersecurity adherence may refer to a number of security events, firmware/operating system/patch upgrade status, ports/channels/protocol traffic statistics, and/or IDS (intrusion detection system) flags. IED life may refer to an age of an IED in cumulative hours with consideration of an acceleration factor. Control operating times may refer to relay event (e.g., trip circuit) operating time excluding circuit breaker operating time. Primary asset condition may refer to health status of an IED based on a signature analysis and/or manufacturing and development functions. Breaker condition may refer to health status based on arcing characteristics, temperature, operating times, and/or manufacturing and development functions. CT/PT condition may refer to health status based on advanced data analytics. IED environment may refer to temperature and humidity of an IED's ambient environment.

In one or more embodiments, external influence factors may include monitoring CT/PT health using a model-based substation linear state estimator (SLSE), which is a model-based approach running linear state estimation at the substation level for 3-phase voltages and currents, and compares linear state estimation to measured data. A discrepancy may imply a measurement anomaly. Another CT/PT health monitoring technique may use advanced data analytics such as a control chart, which may use the average range of a moving window and compare the range to each new data point to detect an anomaly. Another CT/PT health monitoring technique may use advanced data analytics such as moving variance, which compares a moving variance to each new data point to detect an anomaly. By embedding the logic for the calculations into an IED, the IED itself may measure and/or compute the risk index parameters and risk influence factors rather than relying on an external system.

As a result of the enhanced techniques herein, device management software may gain the ability to communicate with all IEDs and to perform secondary asset management. The device management software may retrieve the IED secondary asset management (SAM) data related to primary asset condition/performance, control operating times, IED installation time, cybersecurity details, CT/PT/breaker health, real-time clock accuracy, CPU performance, IED environment, and/or communication latency. During a baseline period, the device management software may perform statistical analysis on the IED SAM data to register a baseline device profile for an individual IED or for a cluster of IEDs.

During a monitoring period, the device management software may continuously receive IED SAM data to identify deviations (e.g., plus rates-of-change) in the data with respect to a baseline profile as below:
[A] Primary asset condition and state performance deviation from normal statistics.
[B] Control operating times deviation from normal statistics.
[C] IED operating age versus warranty period.
[D] Cybersecurity adherence on all ports/channels/patch upgrades.
[E] CT/PT measurement accuracy deviation from normal statistics.
[F] Real-time clock accuracy deviation from normal statistics.
[G] CPU performance deviation from normal statistics.
[H] Communication latency deviation on all ports/channels from normal statistics.
[I] Breaker health state deviation from normal statistics.
[I] CT/PT health state deviation from normal statistics.
[K] IED environmental condition.

The device management system may assign priority of parameters from [A]-[K] above, excluding [A], [I], [J], and [K], to determine the risk index, and using [A], [I], [J], and [K] to determine a risk influence factor on the risk index. The device management system may compute the risk index of an IED on a scale of 1-5 based on the parameters and deviations with scaled priority factors assigned from a baseline. The risk influence factor may be on a scale of 1-2 based on [A], [I], [J], and [K], and deviations with scaled priority factors assigned from the baseline profile. For example, a deviation less than 20% may result in a risk index of 1 and a risk influence factor of 1. A deviation between 20-40% may result in a risk index of 2 and a risk influence factor of 1.2. A deviation between 40-75% may result in a risk index of 3 and a risk influence factor of 1.5. A deviation between 75-90% may result in a risk index of a 4 and a risk influence factor of 1.8. A deviation greater than 90% may result in a risk index of 5 and a risk influence factor of 2. The secondary asset risk index may be the maximum risk index for from [A]-[K] above, excluding [A], [I], [J], and [K], and the secondary asset risk influence factor may be the maximum of [A], [I], [J], and [K]. The final IED risk index may be from secondary asset risk index*secondary asset risk influence factor and a fleet ranking may be based on the final IED risk index of the IEDs in a fleet. The deviations may be the actual magnitude change or a rate-of-change, for example. IEDs with a risk influence factor greater than a threshold (e.g., 1) may be presented in a separate list/table.

The above descriptions are for purposes of illustration and are not meant to be limiting. Numerous other examples, configurations, processes, etc., may exist, some of which are described in greater detail below. Example embodiments will now be described with reference to the accompanying figures.

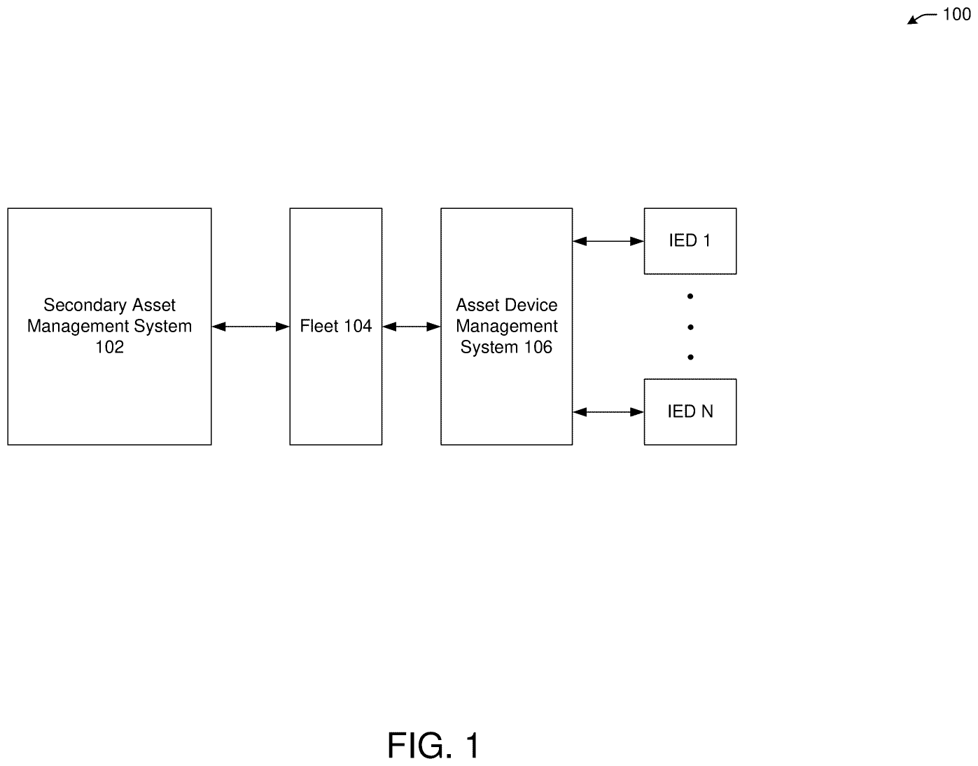

FIG. 1 illustrates an example system 100 for secondary asset management of intelligent electronic devices (IEDs) in power system in accordance with one embodiment of the present disclosure.

Referring to FIG. 1, the system 100 may include a secondary asset management system 102 for a fleet 104 of power system IEDs (e.g., IED 1-IED N). The secondary asset management system 102 may be asset device management-based, using a global asset device management system 106 for process analytics, health analytics, performance analytics, and communications and cybersecurity analytics. The secondary asset management system 102 may provide a user dashboard, secondary asset management functions, lifecycle management, network management, advance metrics for power system assets, secondary asset risk indices and rankings, and secondary asset situational awareness.

In one or more embodiments, the secondary asset management 102 may receive IED secondary asset management data and derive process, performance, health, communications, and cybersecurity analytics from the secondary asset management data at a substation level (e.g., the IEDs per a given substation). At the fleet level (e.g., a fleet of substations), the secondary asset management 102 may extract intelligence by combining IED data at each substation, may provide actionable insights such as a risk index and score to operators for end-to-end management of all IEDs, and may increase overall grid reliability, security, and availability.

In one or more embodiments, the IEDs 1-N may be deployed, configured, and managed over the global asset device management system 106. A secondary asset management algorithm as part of the global asset device management system 106 may track the status, performance, operations, patches, and vulnerabilities, and may compute a risk index and score of each IED for fleet ranking and management.

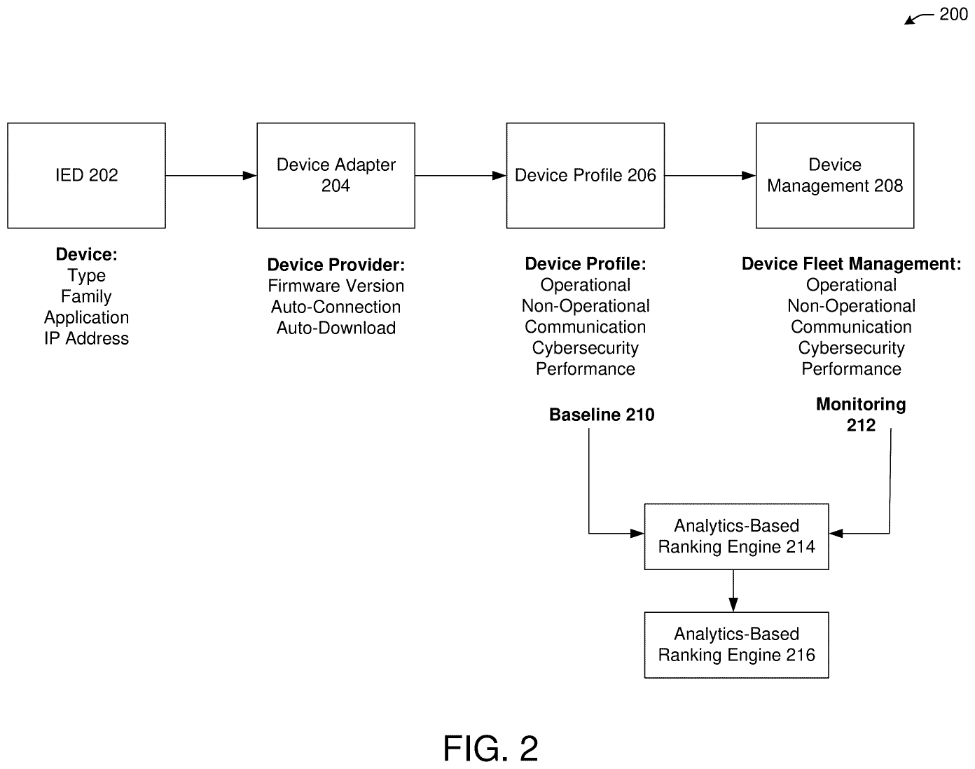

FIG. 2 illustrates an example secondary asset management process 200 in accordance with one embodiment of the present disclosure.

Referring to FIG. 2, an IED 202 (e.g., one of the IEDs 1-N of FIG. 1) of an IED type (e.g., corresponding primary asset), family, application, and IP address may communicate with a device provider 204, which may provide a firmware version, auto-connection to the IED 202, and auto-download to the IED 202. Using secondary asset management data from the IED 202, a device profile 206 may be registered for the IED 202. The device profile 206 may include operational data, non-operational data, communication data, cybersecurity data, and performance data of the IED 202. Device management 208 may monitor additional secondary asset management data from the IED 202 to determine deviations of the additional secondary asset management data and the device profile 206. More particularly, the device profile 206 may include baselines 210 (e.g., from a baseline mode), and the device management 208 may include monitoring the secondary asset management data that are compared to the baselines 210. An analytics-based ranking engine 214 of a secondary asset management system 214 may determine the risk indices, risk influence factors, and final risk indices for an IED.

In one or more embodiments, a baseline device profile 210 may be created using a variety of data types, such as operational data, non-operational data, communication data, cybersecurity performance, and the like. A baseline profile 210 for a given device may indicate baseline performance of the different data types, and may be used to measure a device's (e.g., IED) performance over time. Each IED may establish a baseline profile 210, or a cluster of like IEDs may combine their data to establish a baseline profile 210 for each IED in the cluster (e.g., a 1:1 baseline versus a 1:N baseline).

In one or more embodiments a device baseline profile 210 may include primary asset health, breaker health, current transformer (CT)/potential transformer (PT) health, IED age/runtime, cybersecurity, real-time clock time accuracy, computer performance, communication latency (e.g., for any ports), breaker operation time (e.g., fault level versus operation time), and CT/PT accuracy. The baseline profile data may include historical data of the modes described above.

In one or more embodiments, the device management 208 software may generate a monitoring profile 212 for each IED. The monitoring profile 212 may include a primary asset condition, a circuit breaker condition, a CT/PT condition, IED age versus warranty, cybersecurity adherence, real-time clock deviations, computer performance deviations, communication latency deviations/port, control operation time deviations, and CT/PT data errors. The monitoring software may compare the monitoring profile 212 of a given IED to the baseline profile 210 (e.g., of the IED and/or of the cluster that includes the IED) to detect a deviation indicative of an issue with the IED. Alternatively or in addition, the monitoring profile 212 of an IED may be compared to the baseline profile 210 of another IED (e.g., an IED in a same cluster). The comparisons may be short-term or long-term comparisons, meaning that the time windows during which the monitored data are compared to the baseline profiles may vary in length (e.g., not just a single data point at one time, but multiple data points over time compared to the baseline). The baseline comparison may vary based on the type of data being monitored.

In one or more embodiments, the risk factor for an IED may be influenced based on IED risk influence factors such as the primary asset condition (e.g., condition of a primary asset such as a transformer, etc.), breaker condition, CT/PT condition, and/or IED environment (e.g., temperature and humidity of the environment of the IED). In this manner, the IED risk factor is determined, and then the IED risk influence factors may be used to adjust the IED risk factor. A reason for this is because the internal parameters used in the monitoring mode may not reflect auxiliary conditions or environment of an IED that are indicated by the IED risk influence factors. For example, if there is a problem indicated by the IED risk influence factors, then the IED risk determined based on the monitoring comparison to a baseline may be increased as a result. IEDs not influenced by the IED risk influence factors may be ranked on one table, and IEDs influenced by the IED risk influenced factors may be ranked in another table to signal which IEDs are influenced by external conditions and which are not.

In one or more embodiments, external influence factors may include monitoring CT/PT health using a model-based substation linear state estimator (SLSE), which is a model-based approach running linear state estimation at the substation level for 3-phase voltages and currents, and compares linear state estimation to measured data. A discrepancy may imply a measurement anomaly. Another CT/PT health monitoring technique may use advanced data analytics such as a control chart, which may use the average range of a moving window and compare the range to each new data point to detect an anomaly. Another CT/PT health monitoring technique may use advanced data analytics such as moving variance, which compares a moving variance to each new data point to detect an anomaly. By embedding the logic for the calculations into an IED, the IED itself may measure and/or compute the risk index parameters and risk influence factors rather than relying on an external system.

During a monitoring period, the device management 208 software may continuously receive IED SAM data to identify deviations (e.g., plus rates-of-change) in the data with respect to a baseline profile as below:
[A] Primary asset condition and state performance deviation from normal statistics.
[B] Control operating times deviation from normal statistics.
[C] IED operating age versus warranty period.
[D] Cybersecurity adherence on all ports/channels/patch upgrades.
[E] CT/PT measurement accuracy deviation from normal statistics.
[F] Real-time clock accuracy deviation from normal statistics.
[G] CPU performance deviation from normal statistics.
[H] Communication latency deviation on all ports/channels from normal statistics.
[I] Breaker health state deviation from normal statistics.
[I] CT/PT health state deviation from normal statistics.
[K] IED environmental condition.

The secondary asset management system 216 may assign priority of parameters from [A]-[K] above, excluding [A], [I], [J], and [K], to determine the risk index, and using [A], [I], [J], and [K] to determine a risk influence factor on the risk index. The secondary asset management system 216 may compute the risk index of an IED on a scale of 1-5 based on the parameters and deviations with scaled priority factors assigned from a baseline. The risk influence factor may be on a scale of 1-2 based on [A], [I], [J], and [K], and deviations with scaled priority factors assigned from the baseline profile. For example, a deviation less than 20% may result in a risk index of 1 and a risk influence factor of 1. A deviation between 20-40% may result in a risk index of 2 and a risk influence factor of 1.2. A deviation between 40-75% may result in a risk index of 3 and a risk influence factor of 1.5. A deviation between 75-90% may result in a risk index of a 4 and a risk influence factor of 1.8. A deviation greater than 90% may result in a risk index of 5 and a risk influence factor of 2. The secondary asset risk index may be the maximum risk index for from [A]-[K] above, excluding [A], [I], [J], and [K], and the secondary asset risk influence factor may be the maximum of [A], [I], [J], and [K]. The final IED risk index may be from secondary asset risk index*secondary asset risk influence factor and a fleet ranking may be based on the final IED risk index of the IEDs in a fleet. The deviations may be the actual magnitude change or a rate-of-change, for example. IEDs with a risk influence factor greater than a threshold (e.g., 1) may be presented in a separate list/table.

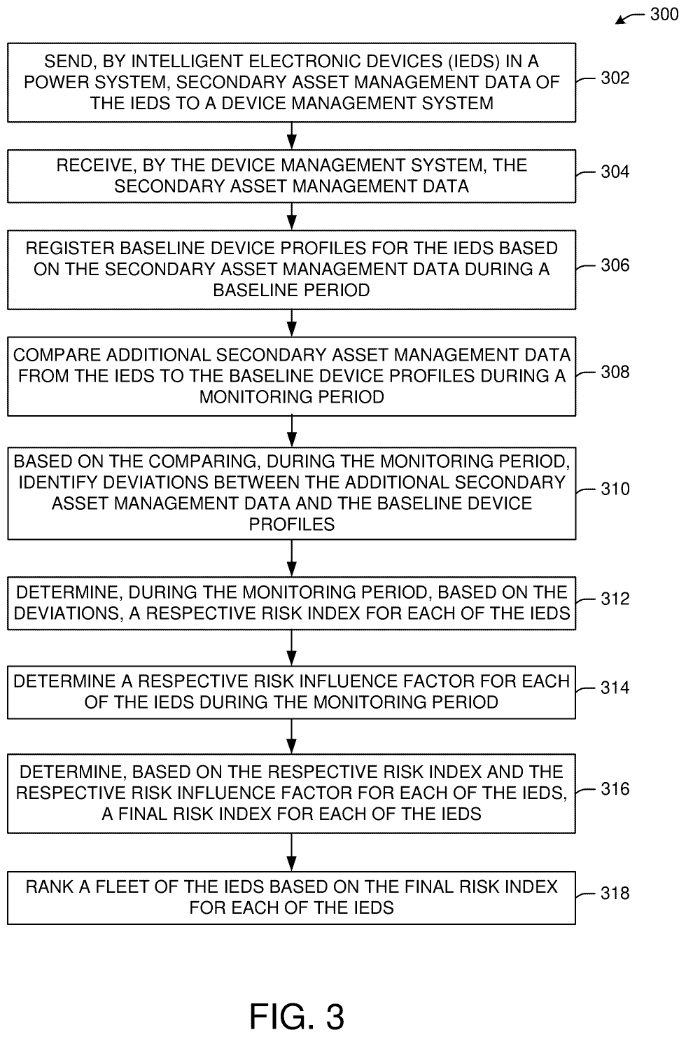

FIG. 3 is an example flow representing a process 300 for secondary asset management of IEDs in a power system in accordance with one embodiment of the present disclosure.

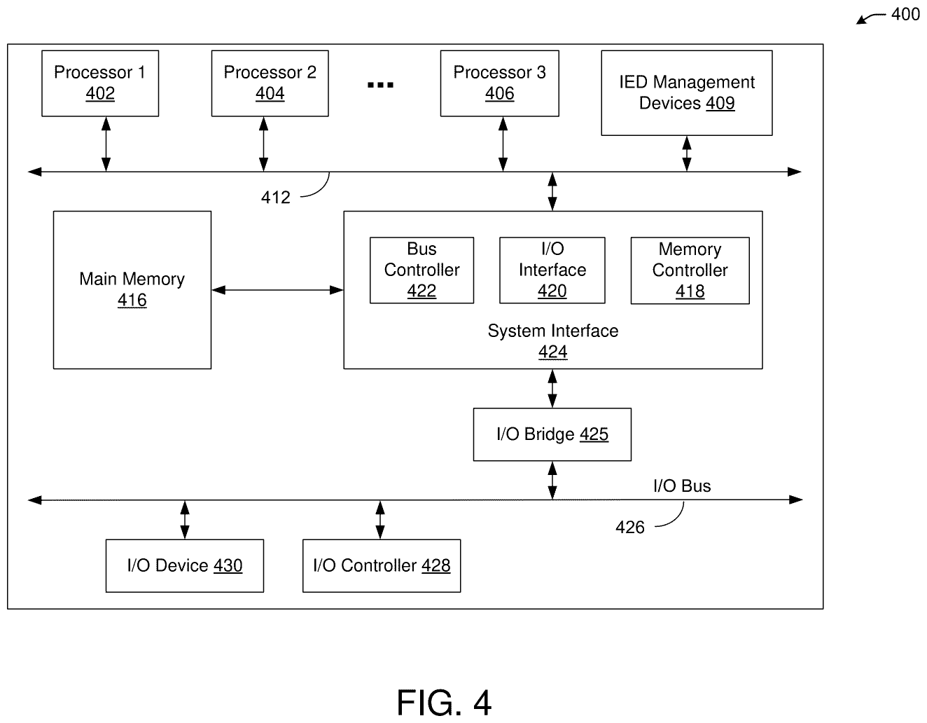

At block 302, IEDs in a power system (e.g., from one or multiple substations) may send their secondary asset management data to a device management system (e.g., the secondary asset management system 102, the IED management devices 409 of FIG. 4).

At block 304, the device management system may receive the secondary asset management data from the IEDs.

At block 306, the device management system may register baseline device profiles for the IEDs based on the secondary asset management data during a baseline period. In one or more embodiments, a device profile may be created using a variety of data types, such as operational data, non-operational data, communication data, cybersecurity performance, and the like. A baseline profile for a given device may indicate baseline performance of the different data types, and may be used to measure a device's (e.g., IED) performance over time. Each IED may establish a baseline profile, or a cluster of like IEDs may combine their data to establish a baseline profile for each IED in the cluster (e.g., a 1:1 baseline versus a 1:N baseline).

At block 308, the device management system may, in a monitoring mode, compare additional secondary asset management data from the IEDs to the baseline profiles. At block 310, the device management system may identify, based on the comparing, deviations between the additional secondary asset management data and the baseline device profiles. In one or more embodiments, the device management software may generate a monitoring profile for each IED. The monitoring profile may include a primary asset condition, a circuit breaker condition, a CT/PT condition, IED age versus warranty, cybersecurity adherence, real-time clock deviations, computer performance deviations, communication latency deviations/port, control operation time deviations, and CT/PT data errors. The monitoring software may compare the monitoring profile of a given IED to the baseline profile (e.g., of the IED and/or of the cluster that includes the IED) to detect a deviation indicative of an issue with the IED. Alternatively or in addition, the monitoring profile of an IED may be compared to the baseline profile of another IED (e.g., an IED in a same cluster). The comparisons may be short-term or long-term comparisons, meaning that the time windows during which the monitored data are compared to the baseline profiles may vary in length (e.g., not just a single data point at one time, but multiple data points over time compared to the baseline). The baseline comparison may vary based on the type of data being monitored.

At block 312, the device management system may, in the monitoring mode, determine a respective risk index for each of the IEDs. The device management system may assign priority of parameters from [A]-[K] above, excluding [A], [I], [J], and [K], to determine the risk index. The device management system may compute the risk index of an IED on a scale of 1-5 based on the parameters and deviations with scaled priority factors assigned from a baseline. This may be calculated for each type of data for the secondary asset management data, and the maximum risk index from among the risk indices may be selected as the risk index for the IED.

At block 314, the device management system may, in the monitoring mode, determine a respective risk influence factor for each of the IEDs. The risk influence factor may be on a scale of 1-2 based on [A], [I], [J], and [K], and deviations with scaled priority factors assigned from the baseline profile. This may be calculated for each type of data for the secondary asset management data, and the maximum risk influence factor from among the risk influence factors may be selected as the risk influence factor for the IED.

At block 316, the device management system may, in the monitoring mode, determine a final risk index of each IED, such as by multiplying the respective risk index and respective risk influence factor.

At block 318, the device management system may rank the IEDs based on their final risk indices. A separate ranking may list the IEDs whose influence factors exceed a threshold value.

It is understood that the above descriptions are for purposes of illustration and are not meant to be limiting.

FIG. 4 is a diagram illustrating an example of a computing system 400 that may be used in implementing embodiments of the present disclosure.

The computer system 400 (system) includes one or more processors 402-406 and IED management devices 409 (e.g., representing the secondary asset management system 102 and/or the asset device management system 106 of FIG. 1), capable of performing the IED management of FIGS. 1-3. Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers include an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for managing intelligent electronic devices (IEDs) or secondary assets in a power grid or industrial system, which further protect, monitor, and manage primary assets comprising a transformer, a generator, and motor, and which control an associated breaker in case of faults or events, based on measured data sent from associated current and voltage transformers in the grid or industrial system, the method comprising:
sending, by IEDs in a power system, secondary asset management data of the IEDs to at least one device of a device management system or software in communication with the IEDs;
receiving, by the at least one device, the secondary asset management data and additional secondary asset management data from the IEDs to map each secondary asset unique tag (IED) with a corresponding primary asset and an associated breaker, and current and voltage transformer unique tags in a database;
during a baseline period, registering, by the at least one device, baseline device profiles for the IEDs using the secondary asset management data and the additional secondary asset management data;
forming, by the at least one device, baseline IED clusters based on similar statistical data profiles of the IEDs and applications, ages, and manufacturer type of the IEDs;
during a monitoring period, comparing, by the at least one device, latest retrieved secondary asset management data from the IEDs to the baseline device profile of a same IED and a corresponding IED cluster profile of the same IED;
during the monitoring period, identifying, by the at least one device, based on the comparing, deviations between the latest secondary asset management data and at least one of the baseline device profile or the corresponding IED cluster profile;
during the monitoring period, determining, by the at least one device, based on the deviations, a respective risk index for each of the IEDs;
during the monitoring period, determining, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs;
during the monitoring period, determining, by the at least one device, based on the respective risk index and the respective risk influence factor for each of the IEDs, a final risk index for each of the IEDs; and
ranking, by the at least one device, a fleet of the IEDs based on the final risk index for each of the IEDs.

2. The method of claim 1, wherein:
the secondary asset management data comprises condition and performance data of primary assets corresponding to the IEDs, control operating times of the IEDs, IED installation times, cybersecurity details of the IEDs, current transformer and potential transformer health data, breaker health data, real-time clock accuracy data, computer performance data, temperature and humidity data, and communication latency data, and
determining the respective risk influence factor is based on a deviation of the condition and performance data of the primary assets from a respective baseline of the baseline device profiles, a deviation of the breaker health data from a respective baseline of the device profiles, a deviation of the current transformer and potential transformer data from a respective baseline of the baseline device profiles, and a deviation of the temperature and humidity data from a respective baseline of the baseline device profiles.

3. The method of claim 1, wherein at least one of the deviations is from a baseline set for a respective IED using only respective secondary asset management data of the respective IED.

4. The method of claim 1, further comprising:
generating the baseline IED clusters based on characteristics comprising a baseline profile of the secondary asset management data.

5. The method of claim 4, wherein at least one of the deviations is from a baseline set for all IEDs in a cluster of IEDs that comprises the IED for which the risk index is being determined.

6. The method of claim 4, wherein at least one of the deviations is from a baseline set for a different IED in a same cluster as the IED for which the risk index is being determined.

7. The method of claim 1, wherein a respective baseline profile comprises respective baselines for each type of the secondary asset management data.

8. The method of claim 7, wherein determining the risk index comprises:
determining a respective deviation for each type of the secondary asset management data;
determining a respective risk index for each type of the secondary asset management data based on the respective deviation; and
identifying a maximum risk index from the risk index for each type of the secondary asset management data.

9. The method of claim 7, wherein determining the risk influence factor comprises:
determining a first deviation of condition and performance data of primary assets corresponding to the IEDs from a first respective baseline of the baseline device profiles;
determining a second deviation of breaker health data from a second respective baseline of the device profiles;
determining a third deviation of current transformer and potential transformer data from a third respective baseline of the baseline device profiles;
determining a fourth deviation of temperature and humidity data from a fourth respective baseline of the baseline device profiles
determining a respective risk influence factor based on each of the first deviation, the second deviation, the third deviation, and the fourth deviation; and
identifying a maximum risk influence factor from the respective risk influence factors.

10. The method of claim 1, wherein at least one of the deviations is based on a magnitude of a respective type of the additional secondary asset management data during a time period greater than an instant.

11. The method of claim 1, wherein at least one of the deviations is based on a rate of change of a respective type of the additional secondary asset management data.

12. The method of claim 1, wherein the final risk index is a respective risk index multiplied by a respective risk influence factor.

13. A non-transitory computer-readable medium comprising instructions that when executed by processing circuitry of a power system cause the processing circuitry to:
send, by IEDs in a power system, secondary asset management data of the IEDs to at least one device of a device management system or software in communication with the IEDs;
receive, by the at least one device, the secondary asset management data and additional secondary asset management data from the IEDs to map each secondary asset unique tag (IED) with a corresponding primary asset and an associated breaker, and current and voltage transformer unique tags in a database;
during a baseline period, register, by the at least one device, baseline device profiles for the IEDs using the secondary asset management data and the additional secondary asset management data;
form, by the at least one device, baseline IED clusters based on similar statistical data profiles of the IEDs and applications, ages, and manufacturer type of the IEDs;
during a monitoring period, compare, by the at least one device, latest retrieved secondary asset management data from the IEDs to the baseline device profile of a same IED and a corresponding IED cluster profile of the same IED;
during the monitoring period, identify, by the at least one device, based on the comparing, deviations between the latest secondary asset management data and at least one of the baseline device profile or the corresponding IED cluster profile;
during the monitoring period, determine, by the at least one device, based on the deviations, a respective risk index for each of the IEDs;
during the monitoring period, determine, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs;
during the monitoring period, determine, by the at least one device, based on the respective risk index and the respective risk influence factor for each of the IEDs, a final risk index for each of the IEDs; and
rank, by the at least one device, a fleet of the IEDs based on the final risk index for each of the IEDs.

14. The non-transitory computer-readable medium of claim 13, wherein:
the secondary asset management data comprises condition and performance data of primary assets corresponding to the IEDs, control operating times of the IEDs, IED installation times, cybersecurity details of the IEDs, current transformer and potential transformer health data, breaker health data, real-time clock accuracy data, computer performance data, temperature and humidity data, and communication latency data, and
determining the respective risk influence factor is based on a deviation of the condition and performance data of the primary assets from a respective baseline of the baseline device profiles, a deviation of the breaker health data from a respective baseline of the device profiles, a deviation of the current transformer and potential transformer data from a respective baseline of the baseline device profiles, and a deviation of the temperature and humidity data from a respective baseline of the baseline device profiles.

15. The non-transitory computer-readable medium of claim 13, wherein at least one of the deviations is from a baseline set for a respective IED using only respective secondary asset management data of the respective IED.

16. The non-transitory computer-readable medium of claim 13, wherein execution of the instructions further causes the processing circuitry to:
generate the baseline IED clusters based on characteristics comprising a baseline profile of the secondary asset management data.

17. The non-transitory computer-readable medium of claim 16, wherein at least one of the deviations is from a baseline set for all IEDs in a cluster of IEDs that comprises the IED for which the risk index is being determined.

18. The non-transitory computer-readable medium of claim 16, wherein at least one of the deviations is from a baseline set for a different IED in a same cluster as the IED for which the risk index is being determined.

19. A system for managing intelligent electronic devices (IEDs) in a power system, the system comprising memory coupled to at least one processor, wherein the at least one processor is configured to:
send, by IEDs in a power system, secondary asset management data of the IEDs to at least one device of a device management system or software in communication with the IEDs;
receive, by the at least one device, the secondary asset management data and additional secondary asset management data from the IEDs to map each secondary asset unique tag (IED) with a corresponding primary asset and an associated breaker, and current and voltage transformer unique tags in a database;
during a baseline period, register, by the at least one device, baseline device profiles for the IEDs using the secondary asset management data and the additional secondary asset management data;
form, by the at least one device, baseline IED clusters based on similar statistical data profiles of the IEDs and applications, ages, and manufacturer type of the IEDs;
during a monitoring period, compare, by the at least one device, latest retrieved secondary asset management data from the IEDs to the baseline device profile of a same IED and a corresponding IED cluster profile of the same IED;
during the monitoring period, identify, by the at least one device, based on the comparing, deviations between the latest secondary asset management data and at least one of the baseline device profile or the corresponding IED cluster profile;
during the monitoring period, determine, by the at least one device, based on the deviations, a respective risk index for each of the IEDs;
during the monitoring period, determine, by the at least one device, based on the latest retrieved additional secondary asset management data, comprising ambient environmental condition data, primary asset data, breaker data, and current and voltage transformer data, deviating from the corresponding baseline device profiles created using the additional secondary asset management data, a respective risk influence factor for each of the IEDs;
during the monitoring period, determine, by the at least one processor, based on the respective risk index and the respective risk influence factor for each of the IEDs, a final risk index for each of the IEDs; and
rank, by the at least one processor, a fleet of the IEDs based on the final risk index for each of the IEDs.

20. The system of claim 19, wherein:
the secondary asset management data comprises condition and performance data of primary assets corresponding to the IEDs, control operating times of the IEDs, IED installation times, cybersecurity details of the IEDs, current transformer and potential transformer health data, breaker health data, real-time clock accuracy data, computer performance data, temperature and humidity data, and communication latency data, and
determining the respective risk influence factor is based on a deviation of the condition and performance data of the primary assets from a respective baseline of the baseline device profiles, a deviation of the breaker health data from a respective baseline of the device profiles, a deviation of the current transformer and potential transformer data from a respective baseline of the baseline device profiles, and a deviation of the temperature and humidity data from a respective baseline of the baseline device profiles.
